(19) United States
(12) Patent Application Publication
(10) Pub. No.: US 2024/0352940 A1
(43) Pub. Date: Oct. 24, 2024

(54) Splash Ring

(71) Applicant: KSB SE & Co. KGaA, Frankenthal (DE)

(72) Inventors: Joerg Alexander BOEHM, Frankenthal (DE); Tammuz NOBEL, Frankenthal (DE)

(21) Appl. No.: 18/686,496

(22) PCT Filed: Aug. 3, 2022
(86) PCT No.: PCT/EP2022/071802

§ 371 Date: Feb. 26, 2024

(30) Foreign Application Priority Data
Aug. 27, 2021 (DE) 10 2021 122 207.9

(51) Int. Cl. F04D 29/063; F04D 17/08; F04D 29/056; F16C 33/66

(52) U.S. Cl. CPC F04D 29/063; F04D 17/08; F04D 29/056; F16C 33/6659

(57) ABSTRACT

A centrifugal pump includes at least one impeller and a distribution arrangement. The at least one impeller is driven by a shaft. The shaft is rotatably supported by bearings. The distribution arrangement is immersed in a lubricating means. The distribution arrangement is operatively connected to the shaft. The distribution arrangement is configured as a structure formed of at least two elements.

### CROSS REFERENCE TO RELATED APPLICATION

This application claims priority under 35 U.S.C. § 119 from German Patent Application No. 102021122207.9, filed Aug. 27, 2021, the entire disclosure of which is herein expressly incorporated by reference.

### BACKGROUND

The specification relates to a centrifugal pump with at least one impeller, which is driven by a shaft, wherein the shaft is rotatably supported by bearings, and a distribution arrangement, which is immersed in a lubricating means, is operatively connected to the shaft.

Centrifugal pumps are based on the operating principle of transferring energy to a fluid by changing the swirl as a result of a torque produced by a uniformly rotating impeller on the fluid flowing through the impeller. The centrifugal pump is a work machine according to the direction of the energy flow, is a turbomachine according to the type of energy conversion, and is a hydraulic turbomachine according to the type of fluid.

A centrifugal pump generally comprises one or more impellers, which are arranged on a shaft and are driven by one or more electric motors. The electric motor is controlled by electronic equipment for regulating the rotational speed and for inverting the frequency.

A shaft is an elongate, cylindrical and rotating machine element that is used to transfer rotary movements and torques. A shaft is usually assisted by at least two bearings in the machine framework. The bearing may be designed as an axial and/or radial bearing.

A bearing refers to a machine element for guiding components that are movable relative to one another. Bearings enable movements in desired degrees of freedom and prevent movements in the undesired degrees of freedom. In a bearing, the parts that are movable relative to one another are in contact with one another or are more or less separated from one another by a lubricating film. Without this lubricating film, a bearing may rapidly become defective.

For the lubrication of bearings that support centrifugal pump shafts, loose rings or disks are usually pushed onto the shaft. The rotary movement of the shaft usually distributes a lubricating film in an uncontrolled manner in the immediate surroundings, as a result of which a bearing arranged in the surroundings is sometimes also lubricated. In the long term, however, such rings and disks destroy the shaft, since they “eat” into the shaft.

EP 1 396 610 A2 discloses a bearing assembly for rotating a machine element. The assembly comprises a bearing housing, a first housing portion with a first sealing assembly receiving face, a second housing portion, which has a second sealing arrangement receiving face and forms a sump for lubricant, and a sealing arrangement, which is arranged so as to be at least partially in contact with the receiving faces. Furthermore, the assembly comprises a bearing set, which is sealed within the housing by means of the first housing part engaging with the second housing part, and a lubricating ring, which is arranged within the housing in order to extract lubricant from the sump during operation of the arrangement.

### SUMMARY

One object of the specification is to provide a distribution arrangement that supplies the bearings of impeller shafts in centrifugal pumps with lubricant in a reliable and targeted manner. The distribution arrangement should protect the shaft and the bearings from damage and should not cause any damage itself. The distribution arrangement should be configurable individually and in a customer-oriented manner. The distribution arrangement should also be implementable in a simple and cost-effective manner. Furthermore, the distribution arrangement should be as simple as possible to assemble and easy to recycle after it has been used.

This object is achieved according to the specification by a centrifugal pump with at least one impeller. Preferred variants can be found in the dependent claims, the description and the drawings.

According to the specification, the distribution arrangement is designed as a structure formed of at least two elements.

An element is a basic component of a structure and cannot be further broken down without losing its properties. According to the specification, the element may be designed as a ring and/or member, as a sleeve and/or small perforated plate and/or conical hollow body.

Advantageously, the elements of the structure at least partially have a connection to one another and yet are arranged so as to be movable in relation to one another. Such a connection is preferably created directly, for example in the form of interlinked rings. An arrangement of elements connected in this manner forms a sheet-like structure, preferably an element chain and/or an element mesh.

In one advantageous variant of the specification, the elements of the structure have a connection to one another. This connection is preferably created between adjacent elements and in this case involves at least two adjacent elements. In addition, it is also possible for three, preferably four, in particular five, adjacent elements to have a connection to a common element, which results in a thread-like to sheet-like structure.

In one preferred variant of the specification, not every element is connected to every other element. Preferably, individual elements only have a connection to one or two surrounding elements. This results in a chain-like structure of elements of the distribution arrangement. In one particularly preferred variant, the distribution arrangement comprises a plurality of chain-like structures, which convey lubricant to bearings of the impeller shaft arranged in the vicinity in a particularly advantageous and targeted manner.

Ideally, in the stationary state, at least one open chain of elements hangs into the lubricant and in turn causes the lubricant to move toward the bearings. In one alternative variant of the specification, the distribution arrangement has a thread-like and/or helical design.

Preferably, the elements of the structure are arranged so as to be at least partially movable in relation to one another, which particularly facilitates the flexibility of the distribution arrangement and, as a result, the conveying of the lubricant as well.

In one favorable variant of the specification, the elements of the structure interlock, as a result of which the distribution arrangement has a particularly flexible configuration. On account of the flexible connection, the arrangement of the elements in relation to one another may be influenced on the basis of external forces, in particular in the form of the rotary movement, which results in lubricant being supplied to the shaft bearings in a targeted manner.

Advantageously, the elements of the structure have cavities through which the lubricant may flow and be carried along by a rotary movement of the elements for the targeted application of lubricant. Depending on the configuration of the elements, the cavities are larger or smaller and therefore configurable for a desired transportation of lubricant.

Preferably, at least some elements are designed as rings and/or as hollow members. As a result, the structure of the distribution arrangement has a particularly filigree and flexible design. Such a configuration of the elements achieves a distribution arrangement that can be produced with particularly low material usage and at the same time conveys lubricant to the locations to be lubricated in a particularly efficient manner.

In one particularly favorable variant of the specification, at least one element is designed as a conveying member. Such a conveying member, for example in the form of a bucket or a scoop, is connected to at least one further element and therefore to the distribution arrangement. The conveying member has a component geometry that can move a particularly large amount of lubricant in a targeted manner.

The distribution arrangement lubricates the bearings of impeller shafts in centrifugal pumps particularly efficiently when the distribution arrangement is arranged between two bearings. The specific design of the distribution arrangement enables at least two bearings to be lubricated in a targeted manner by just one distribution arrangement.

Preferably, the lubricating means is arranged in a reservoir, in particular a trough, in which the distribution arrangement is immersed in the idle state and through which the distribution arrangement slides in the movement state. As a result of this and the particular design of the elements, the distribution arrangement conveys the lubricant for lubricating the impeller shaft in a particularly favorable manner without this causing damage to the impeller shaft itself.

In one favorable design variant of the specification, the distribution arrangement comprises a cylindrical contact element, which is operatively connected to the shaft. As a result, the distribution arrangement is preferably connected to the shaft in a rotationally fixed manner. Preferably, the contact element comprises at least one anchoring element, to which at least one element of the structure is connected by means of interlocking.

Ideally, the elements of the structure that form the distribution arrangement are additively manufactured. It is only by virtue of this particular manufacturing technology that the structure can be produced in a flexible manner, with the lowest possible material usage and very rapidly. In particular, the connection of the elements, which are at the same time arranged so as to be partially movable in relation to one another, to one another can only be achieved using additive manufacturing technology.

An additively manufactured structure formed of at least two elements has been generated using an additive manufacturing process. The designation “additive manufacturing process” includes all manufacturing processes in which material is deposited layer by layer and consequently three-dimensional elements are produced. A computer is used to control the layer-wise construction of one or more liquid or solid materials according to predefined dimensions and shapes. During the construction, physical or chemical curing or melting processes take place. Typical materials for 3D printing are plastics materials, synthetic resins, ceramics, metals, carbon materials and graphite materials.

Generative or additive manufacturing processes are understood to mean processes in which material is deposited layer by layer in order to produce a three-dimensional structure formed of elements. According to the specification, the distribution arrangement is designed as an additively manufactured structure formed of at least two elements. In particular, selective laser melting and cladding, which is also known as deposition welding, are used for forming the elements. In one alternative variant of the specification, extrusion in combination with deposition of fusible plastics material is also a process that can be used.

In the case of selective laser melting, an element of the structure is produced by a process in which a layer of construction material is first applied to a substrate. Preferably, the construction material for producing the element is metallic powder particles. In one variant of the specification, iron-containing and/or cobalt-containing powder particles are used for this purpose. These may contain additives such as chromium, molybdenum or nickel. A thin layer of the metallic construction material is applied in powder form to a plate. The pulverulent material is then locally completely melted at the respective desired locations by means of radiation and, after solidification, a solid material layer is formed. The substrate is subsequently lowered by the amount of one layer thickness and powder is deposited once again. This cycle is repeated until all of the layers have been produced and the finished element has been formed. According to the specification, this produces elements of a structure that is particularly filigree and optimized as a distribution arrangement. It is not technically possible for the elements to be produced using conventional processes.

The radiation used may be a laser beam, for example, which generates the element from the individual powder layers. The data for guiding the laser beam are produced by means of software on the basis of a 3D CAD body. As an alternative to selective laser melting, an electron beam (EBM) may also be used.

In the case of deposition welding or cladding, the element is produced by a process that coats an initial piece by welding. By means of a welding filler material in the form of a wire or a powder, deposition welding constructs a volume that achieves a form of the element that is particularly filigree and optimized.

The configuration with the contact element, which may be manufactured conventionally or generatively, renders the distribution arrangement particularly easy to assemble. The material of the distribution arrangement may be returned to the material cycle by being recycled after it has been used in the centrifugal pump.

In one alternative variant of the specification, the elements are designed to form an annular structure. The elements themselves are designed as small rings that interlock and are combined to form a large ring, which is preferably not connected to the shaft in a rotationally fixed manner.

The particular structure of the distribution arrangement achieves a uniform distribution of lubricant in the surrounding space and supplies the bearings of the impeller shaft with lubricant in a particularly reliable manner. This enables continuous and long-lasting operation of the centrifugal pump.

The elements of the structure that interlock and are arranged so as to be movable in relation to one another and the cavities in the elements in combination with the rotary movement of the shaft result in lubricant preferably also being conveyed via internal ducts in the structure. The advantageous design of the end element produces an optimal ejection angle for the lubricant, as a result of which the bearings mounted in the vicinity of the distribution arrangement are lubricated in a targeted, safe and sufficient manner.

In another variant of the specification, a lubricant reservoir with a distribution arrangement is provided at each bearing of the impeller shaft.

In one particularly favorable embodiment of the specification, the elements of the structure are formed in a targeted manner with a macroporosity by means of selective laser melting. This porosity of the elements and the rotary movement of the shaft achieve transportation of lubricant via internal ducts in the distribution arrangement and reliable lubrication of the bearings.

According to the specification, the distribution arrangement is used to lubricate the bearings on shafts of turbomachines, in particular on centrifugal pumps with at least one impeller.

Further features and advantages of the specification will become apparent from the description of exemplary embodiments with reference to the drawings and from the drawings themselves, in which:

### BRIEF DESCRIPTION OF THE DRAWINGS

FIG. 1 shows a sectional illustration of a multi-stage centrifugal pump according to the prior art;

FIG. 2 shows an illustration of a detail of a centrifugal pump with a lubricant reservoir according to the prior art;

FIG. 3 shows a design variant of the distribution arrangement; and

FIG. 4 shows a design variant of the distribution arrangement with conveying members.

### DETAILED DESCRIPTION

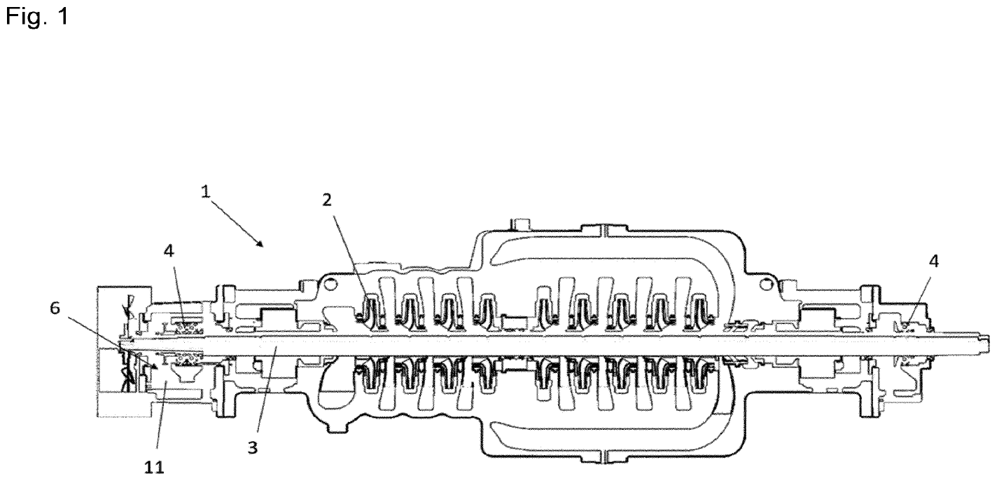

FIG. 1 shows, by way of example, a centrifugal pump 1 in the form of a spiral housing pump, which is horizontal, axially split, single-flow, multi-stage, supported on both sides and has a single housing and counter-rotating impellers 2 according to the prior art. The high-pressure pump has nine impellers 2, which are arranged in a partially counter-rotating manner for the purpose of axial thrust compensation. The shaft 3 is supported at both ends by way of bearings 4, which are designed as a roller bearing arrangement in this embodiment. In order to ensure a high pump availability, the roller bearings are continuously lubricated with a lubricating means 6. The lubricating means 6 is stored in a reservoir 11.

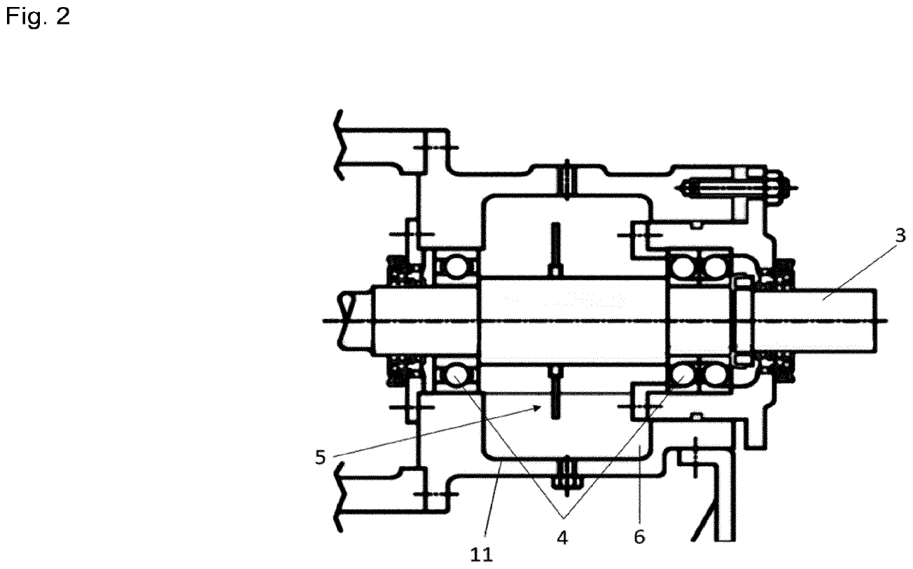

FIG. 2 illustrates a detail of the shaft bearing arrangement of a known centrifugal pump 1 with a lubricant reservoir 11. The shaft 3 is rotatably supported by three bearings 4. In this variant, the distribution arrangement 5 is designed as a disk that is loosely attached to the shaft 3. The disk is immersed in a lubricating means 6, which is stored in the reservoir 11. The rotary movement of the shaft 3 causes the disk to rotate therewith, which in turn causes lubricant 6 to be distributed in an undirected manner. The surrounding bearings 4 are thus also supplied with lubricant 6.

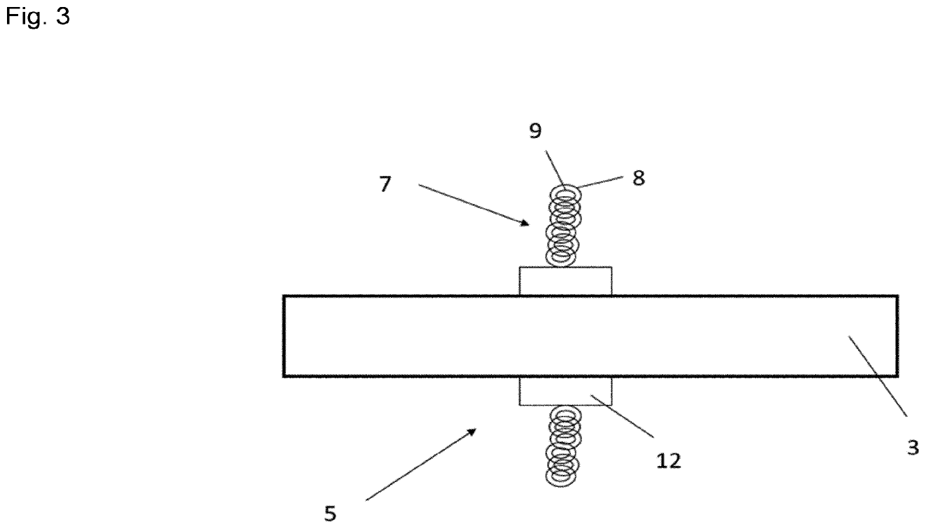

FIG. 3 shows a design variant of the distribution arrangement 5. The distribution arrangement 5 is connected to the shaft 3 in a rotationally fixed manner by way of the contact element 12. In this design variant, the contact element 12 is designed as a cylindrical sleeve. In this exemplary embodiment, the structure 7 is formed by two thread-like elements 8, which are formed as an open chain, of the distribution arrangement 5. The elements 8 are produced as generatively manufactured rings that partially have a connection to one another and are partially arranged so as to be loose in relation to one another. The rings each have a cavity 9, which brings about an improved distribution of lubricant. The structure 7 is immersed in a lubricant reservoir-which is not illustrated in this figure-and distributes a lubricating means 6 in a targeted manner toward the bearings 4, which are not illustrated, of the shaft bearing arrangement. Depending on the positioning of the bearings 4 to be lubricated, the structure 7 can assume another position on the contact element 12. Likewise, according to the position of the bearings 4, the contact element 12 can be correspondingly positioned on the shaft. In addition, the connection of the elements 8 can be configured such that the lubricant 6 is conveyed directly toward the bearings 4.

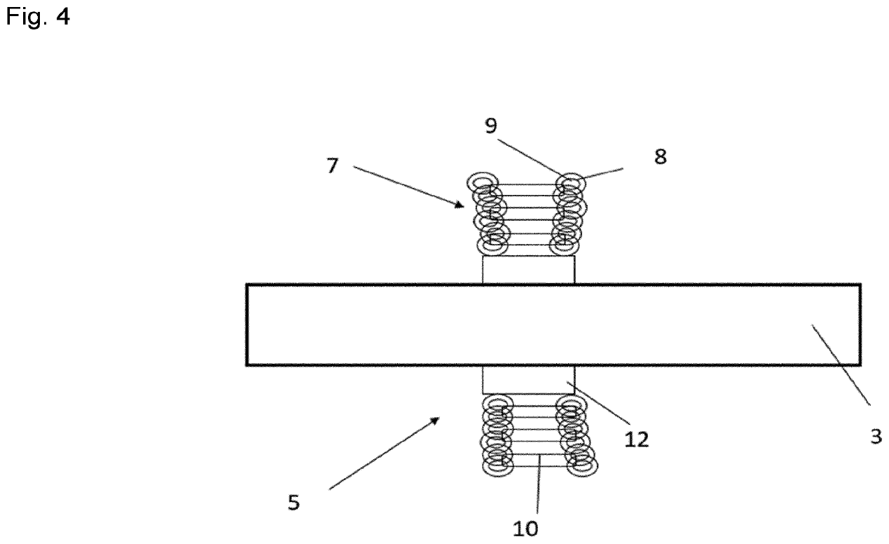

FIG. 4 illustrates a design variant of the distribution arrangement 5 with a plurality of conveying members 10. The distribution arrangement 5 is connected to the shaft 3 in a rotationally fixed manner by way of the contact element 12. In this design variant, the contact element 12 is designed as a cylindrical sleeve. The structure 7 comprises in each case two open chains of additively produced elements 8, which are connected to one another and are arranged so as to be partially movable, between which in each case individual, generatively produced conveying members 10 are arranged so as to be movable. It is possible for two or three or four or a plurality of such a structure 7 to be arranged, in each case in an offset manner, on the contact element 12. The trapezoidal shape of the structure 7 promotes the safe, reliable and targeted distribution of a lubricating means 6 onto bearings 4 positioned next to the distribution arrangement 5.

The foregoing disclosure has been set forth merely to illustrate the disclosure and is not intended to be limiting. Since modifications of the disclosed embodiments incorporating the spirit and substance of the disclosure may occur to persons skilled in the art, the disclosure should be construed to include everything within the scope of the appended claims and equivalents thereof.

1-12. (canceled)

13. A centrifugal pump comprising:
at least one impeller, which is driven by a shaft, wherein the shaft is rotatably supported by bearings; and
a distribution arrangement, which is immersed in a lubricating means, and is operatively connected to the shaft, wherein
the distribution arrangement is configured as a structure formed of at least two elements.

14. The centrifugal pump as claimed in claim 13, wherein the at least two elements of the structure have a connection to one another.

15. The centrifugal pump as claimed in claim 13, wherein the at least two elements are arranged so as to be at least partially movable in relation to one another.

16. The centrifugal pump as claimed in claim 13, wherein the at least two elements at least partially interlock.

17. The centrifugal pump as claimed in claim 13, wherein the at least two elements have cavities.

18. The centrifugal pump as claimed in claim 17, wherein the at least two elements are configured as rings.

19. The centrifugal pump as claimed in claim 18, wherein at least one of the at least two elements is configured as a conveying member.

20. The centrifugal pump as claimed in claim 13, wherein the distribution arrangement is disposed between two bearings.

21. The centrifugal pump as claimed in claim 13, wherein the lubricating means is arranged in a reservoir.

22. The centrifugal pump as claimed in claim 21, wherein the distribution arrangement comprises a cylindrical contact element.

23. The centrifugal pump as claimed in claim 22, wherein the distribution arrangement is additively manufactured.

24. A method comprising:
using the distribution arrangement as claimed in claim 13 to lubricate the bearings on shafts of turbomachines.
